(19) United States
(12) Patent Application Publication
(10) Pub. No.: US 2024/0004960 A1
(43) Pub. Date: Jan. 4, 2024

(54) TELECOMMUNICATION NETWORK FEATURE SELECTION FOR BINARY CLASSIFICATION

(71) Applicant: AT&T Intellectual Property I, L.P., Atlanta, GA (US)

(72) Inventors: Vladimir Sevastyanov, Fort Worth, TX (US); James Pratt, Round Rock, TX (US); Nikhlesh Agrawal, McKinney, TX (US); Abhay Dabholkar, Frisco, TX (US); Rakhi Gupta, Frisco, TX (US)

(21) Appl. No.: 17/856,988

(22) Filed: Jul. 2, 2022

(51) Int. Cl. G06K 9/62; G06K 9/00

(52) U.S. Cl. CPC G06K 9/6261; G06K 9/00523; H04W 24/02

(57) ABSTRACT

A processing system including at least one processor may obtain a data set comprising a plurality of records, each record associating at least one feature value of at least one feature with a value of a target variable. The processing system may next segregate the plurality of records into a plurality of subsets based upon a range of values of the at least one feature and calculate a plurality of sub-volumes for the plurality of subsets, each sub-volume comprising a sum of the values of the target variable from records in a respective subset. The processing system may then generate a significance metric that is based on a difference between a highest sub-volume and a lowest sub-volume of the plurality of sub-volumes and select the at least one feature to train a classification model associated with the target variable, based upon the significance metric.

The present disclosure relates generally to classification models, e.g., machine learning-based models, and more particularly to methods, non-transitory computer-readable media, and apparatuses for selecting a feature to train a classification model associated with a target variable based upon a significance metric that is based on a difference between a highest sub-volume and a lowest sub-volume for subsets of records of a data set including feature values of the feature.

### BRIEF DESCRIPTION OF THE DRAWINGS

The present disclosure can be readily understood by considering the following detailed description in conjunction with the accompanying drawings, in which:

FIG. 1 illustrates one example of a system including a telecommunication service provider network, according to the present disclosure;

FIG. 2 illustrates an example flowchart of a method for significance estimation of a numeric feature, in accordance with the present disclosure;

FIG. 3 illustrates the performance of calculations according to the example method of FIG. 2 for an example table, in accordance with the present disclosure;

FIG. 4 illustrates a graph of normalized target sums for feature sub-intervals for the same or similar example as FIG. 3, but with a larger number of sub-intervals;

FIG. 5 illustrates two graphs for comparison of the significance of two features, in accordance with the present disclosure;

FIG. 6 illustrates an example flowchart of a method for significance estimation of a categorical feature, in accordance with the present disclosure;

FIG. 7 illustrates example results of feature significance estimation for a categorical feature which has ten unique categorical values, in accordance with the present disclosure;

FIG. 8 illustrates two graphs for comparison of the significance of two integer features, in accordance with the present disclosure;

FIG. 9 illustrates an example flowchart of a method for feature selection in the case when multiple features of different types are processed, in accordance with the present disclosure;

FIG. 10 illustrates comparable significance of categorical and integer features (column delta) impacting a binary target variable for a classification task (e.g., churn) in a table, according to the present disclosure;

FIG. 11 illustrates confusion matrices in normalized form for classification results for the model built on the 70 most significant features and the 70 least significant features in the table of FIG. 10;

FIG. 12 illustrates an example flowchart of a method for selecting a feature to train a classification model associated with a target variable based upon a significance metric that is based on a difference between a highest sub-volume and a lowest sub-volume for subsets of records of a data set including feature values of the feature; and

FIG. 13 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and apparatuses for selecting a feature to train a classification model associated with a target variable based upon a significance metric that is based on a difference between a highest sub-volume and a lowest sub-volume for subsets of records of a data set including feature values of the feature. For instance, in one example, a processing system including at least one processor may obtain a data set comprising a plurality of records, each record of the plurality of records associating at least one feature value of at least one feature with a value of a target variable. The processing system may next segregate the plurality of records into a plurality of subsets based upon a range of values of the at least one feature and calculate a plurality of sub-volumes for the plurality of subsets, each sub-volume of the plurality of sub-volumes comprising a sum of the values of the target variable from records of the plurality of records in a respective subset of the plurality of subsets. The processing system may then generate a significance metric that is based on a difference between a highest sub-volume and a lowest sub-volume of the plurality of sub-volumes and select the at least one feature to train a classification model associated with the target variable, based upon the significance metric.

In machine learning feature selection is the process of selecting a subset of relevant features (variables, predictors) for use in model construction. Feature selection techniques are used for several reasons: simplification of models to make them easier to interpret by researchers, shorter training times, and to avoid the curse of dimensionality. The central premise when using a feature selection technique is that the data contains some features that are unrelated to the target variable and can thus be removed without experiencing noticeable loss of information. There are three main categories of feature selection algorithms: wrappers, filters, and embedded methods. Examples of the present disclosure belong to the class of filter feature selection methods.

In particular, examples of the present disclosure provide for feature selection for binary classification tasks. In one example, the present disclosure estimates significance of impact of numeric, integer, logical, and categorical variables to a binary target variables. For instance, the present disclosure may process an input table with several features and a target variable to calculate a global volume, which is a total sum of target variable values, and a sub-volume for subsets of the table, where a sub-volume is a sum of target variable values calculated on a subset of the table. To illustrate, in one example, the process may include: (a) dividing the table into subsets based on a feature values, (b) calculating a sub-volume for each subset, (c) determining the difference between maximum and minimum sub-volumes among all subsets, and (d) generating an estimate of the significance of the feature by dividing the difference by the global volume. Step (c) provides for normalizing the significance and guarantees that the significance value, or score will be between 0 and 1.

In one example, the process may further include estimating significance for all or a plurality of features per steps a-d above, and then (e) filtering the most significant features with significance values exceeding a threshold. Filtered in this way, the most significant features can be used to construct a predictive model (e.g., where the other features omitted from use as predictor variables for the model). Notably, this approach allows the use of the same process/algorithm for all types of features (numeric, integer, logical, and categorical) for binary target variables, which may be used for binary classification tasks.

For instance, a binary target variable may have two values: 1 and 0 (or other values, which may be represented as 1 and 0 for illustrative purposes, such as “yes”/“no”, etc.). Thus, a global volume is equal to the sum of all occurrences of “1” in the entire table, and a sub-volume is a sum of all occurrences of “1” in a subset of the table. However, extracting subsets from the table based on feature values may be different for different types of features. For example, for a categorical feature, the process may extract a subset from the table for each categorical value and calculate sub-volume within the extracted subset. For a numeric feature, the process may: (a) determine a range of the feature, (b) split the range into a set of equal subintervals, (c) extract a subset for each subinterval, and (d) calculate sub-volume within the extracted subset. Integer and binary features may be processed in the same way as categorical features. For instance, each distinct value of such a feature may be considered as a value of a categorical feature and processed accordingly.

It should be noted that the present disclosure provides a filter feature selection process that is equally applicable to all types of features, including numeric, integer, binary, and categorical. In addition, since the process can work with all types of features, it does not require any preprocessing of input data. Input data of any volume can be loaded and processed quickly and reliably. Examples of the present disclosure also provide various improvements over other filter methods. For instance, an information gain technique is based on information theory and operates by calculating mutual information as score between each feature and target variable, and then filtering the most significant features by a threshold. However, this technique may perform poorly for features with a large number of distinct values because of overfitting issue. In addition, the chi-square test can be used for feature selection by testing the relationships between the features. However, chi-square is sensitive to small frequencies in cells of the tables. Generally, when the expected value in a cell of a table is less than 5, chi-square can lead to errors in conclusions. Also, chi-square can be applied to categorical features, and cannot be applied to continuous features. Another technique, Fisher score, operates by finding a subset of features such that, in the data space spanned by the selected features, the distances between data points in different classes are as large as possible, while the distances between data points in the same class are as small as possible. Calculating the Fisher score is a combinatorial optimization problem, which may require a large computational effort. Also, the Fisher score technique cannot be applied to categorical features.

Still another technique, correlation coefficient, utilizes a well-known similarity measure between two features. If two features are linearly dependent, then their correlation coefficient is ±1. If the features are uncorrelated, the correlation coefficient is 0. If correlation between a feature and target variable is higher than a threshold value (say 0.5), then the feature will be selected. However, the correlation technique can be used only for continuous features and continuous target variables. If a target variable is binary and/or features are categorical, then this technique is not applicable. Lastly, a variance threshold algorithm is an unsupervised technique, which ignores the target variable and considers just a feature. It calculates a variance value for each feature, and then filters out all the features with variance values lower than a threshold. It is assumed that all available features are relevant to the target variable. Then the feature with the largest variance may be assumed to have the most impact to the target variable. However, if a feature with high variance is irrelevant, which often happens in practical machine learning problems, the feature will not be filtered out, and will be used in the model construction and operation process, causing negative consequences. Another disadvantage is an inability to work with categorical features.

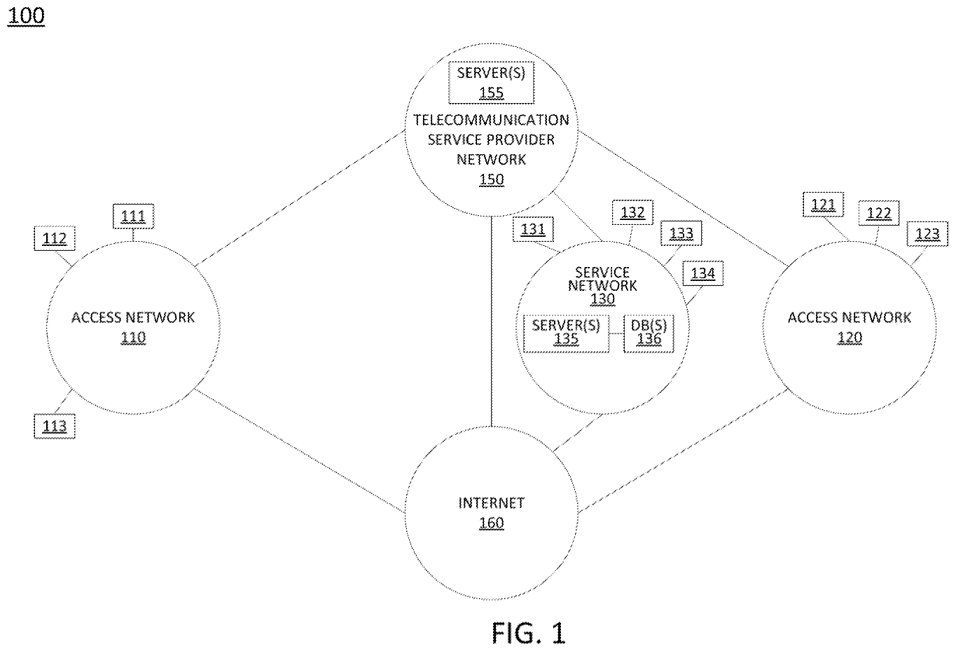

In contrast to such techniques, the present disclosure provides a filter feature selection process that is computationally efficient and that can be applied to the most challenging classification tasks, e.g., with hundreds and thousands of features of different types, and with millions of input table rows. Typically, feature selection is a semi-manual process, which can take weeks and even months for a data scientist to find the most significant features and build an accurate and sufficiently simple classification model. Exploration analysis in data science projects may consume 80% or more of time and other resources. The present disclosure reduces exploration analysis dramatically by streamlining the feature selection process in an automated way. Examples of the present disclosure are able to process, for instance, 1000-3000 features in 20-30 minutes, automatically selecting the most significant features with significance values above a threshold. Thus, examples of the present disclosure allow for the building of classification models much earlier in a project. In addition, the ability of the present disclosure to process different types of features also enables the comparison of significance of features of different types; for instance, comparing the relative significance of categorical and numeric features for the same predictive modeling task. This creates unique opportunities for a deeper understanding of a domain, and for a higher quality classification results. These and other aspects of the present disclosure are discussed in greater detail below in connection with the examples of FIGS. 1-13.

To aid in understanding the present disclosure, FIG. 1 illustrates an example system 100 comprising a plurality of different networks in which examples of the present disclosure may operate. Telecommunication service provider network 150 may comprise a core network with components for telephone services, Internet services, and/or television services (e.g., triple-play services, etc.) that are provided to customers (broadly “subscribers”), and to peer networks. In one example, telecommunication service provider network 150 may combine core network components of a cellular network with components of a triple-play service network. For example, telecommunication service provider network 150 may functionally comprise a fixed-mobile convergence (FMC) network, e.g., an IP Multimedia Subsystem (IMS) network. In addition, telecommunication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication service provider network 150 may also further comprise a broadcast television network, e.g., a traditional cable provider network or an Internet Protocol Television (IPTV) network, as well as an Internet Service Provider (ISP) network. With respect to television service provider functions, telecommunication service provider network 150 may include one or more television servers for the delivery of television content, e.g., a broadcast server, a cable head-end, a video-on-demand (VoD) server, and so forth. For example, telecommunication service provider network 150 may comprise a video super hub office, a video hub office and/or a service office/central office.

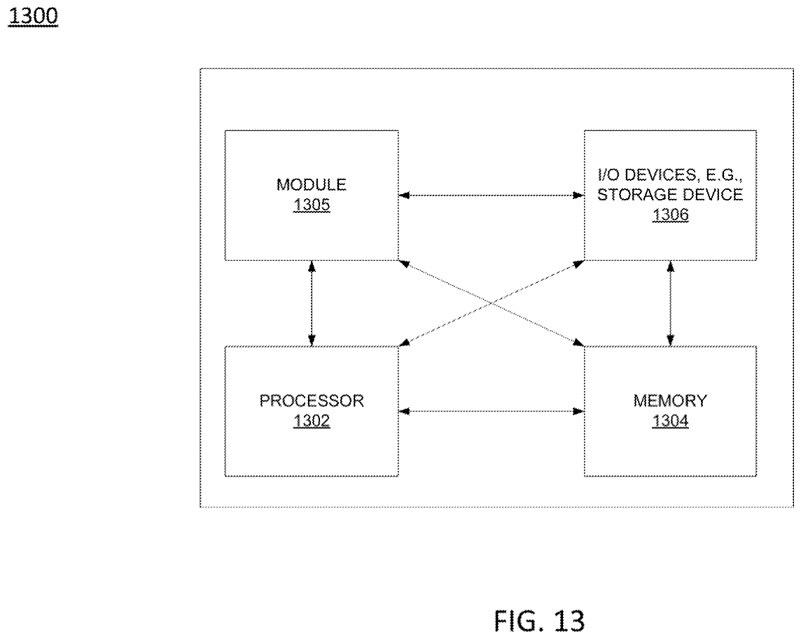

In one example, telecommunication service provider network 150 may also include one or more servers 155. In one example, the servers 155 may each comprise a computing device or system, such as computing system 1300 depicted in FIG. 13, and may be configured to host one or more centralized and/or distributed system components. For example, a first system component may comprise a database of assigned telephone numbers, a second system component may comprise a database of basic customer account information for all or a portion of the customers/subscribers of the telecommunication service provider network 150, a third system component may comprise a cellular network service home location register (HLR), e.g., with current serving base station information of various subscribers, and so forth. Other system components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other system components may include, for example, a layer 3 router, a short message service (SMS) server, a voicemail server, a video-on-demand server, a server for network traffic analysis, and so forth. It should be noted that in one example, a system component may be hosted on a single server, while in another example, a system component may be hosted on multiple servers in a same or in different data centers or the like, e.g., in a distributed manner. For ease of illustration, various components of telecommunication service provider network 150 are omitted from FIG. 1.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113, endpoint devices 121-123, and service network 130, and between telecommunication service provider network 150 and endpoint devices 111-113 and 121-123 relating to voice telephone calls, communications with web servers via the Internet 160, and so forth. Access networks 110 and 120 may also transmit and receive communications between endpoint devices 111-113, 121-123 and other networks and devices via Internet 160. For example, one or both of the access networks 110 and 120 may comprise an ISP network, such that endpoint devices 111-113 and/or 121-123 may communicate over the Internet 160, without involvement of the telecommunication service provider network 150. Endpoint devices 111-113 and 121-123 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like. In one example, any one or more of endpoint devices 111-113 and 121-123 may represent one or more user devices (e.g., subscriber/customer devices) and/or one or more servers of one or more third parties, such as a credit bureau, a payment processing service (e.g., a credit card company), an email service provider, and so on.

In one example, the access networks 110 and 120 may be different types of access networks. In another example, the access networks 110 and 120 may be the same type of access network. In one example, one or more of the access networks 110 and 120 may be operated by the same or a different service provider from a service provider operating the telecommunication service provider network 150. For example, each of the access networks 110 and 120 may comprise an Internet service provider (ISP) network, a cable access network, and so forth. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where telecommunication service provider network 150 may provide service network 130 functions, e.g., of a public land mobile network (PLMN)-universal mobile telecommunications system (UMTS)/General Packet Radio Service (GPRS) core network, or the like. In still another example, access networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, an Internet Protocol private branch exchange (IPPBX), and so forth, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs), enterprise networks, and/or home networks, and the like.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the telecommunication service provider network 150. For example, the service network 130 may comprise one or more devices for providing services to subscribers, customers, and/or users. For example, telecommunication service provider network 150 may provide a cloud storage service, web server hosting, and other services. As such, service network 130 may represent aspects of telecommunication service provider network 150 where infrastructure for supporting such services may be deployed.

In one example, the service network 130 links one or more devices 131-134 with each other and with Internet 160, telecommunication service provider network 150, devices accessible via such other networks, such as endpoint devices 111-113 and 121-123, and so forth. In one example, devices 131-134 may each comprise a telephone for analog or digital telephony, a mobile device, a cellular smart phone, a laptop, a tablet computer, a desktop computer, a bank or cluster of such devices, and the like. In an example where the service network 130 is associated with the telecommunication service provider network 150, devices 131-134 of the service network 130 may comprise devices of network personnel, such as customer service agents, sales agents, marketing personnel, or other employees or representatives who are tasked with addressing customer-facing issues and/or personnel for network maintenance, network repair, construction planning, and so forth.

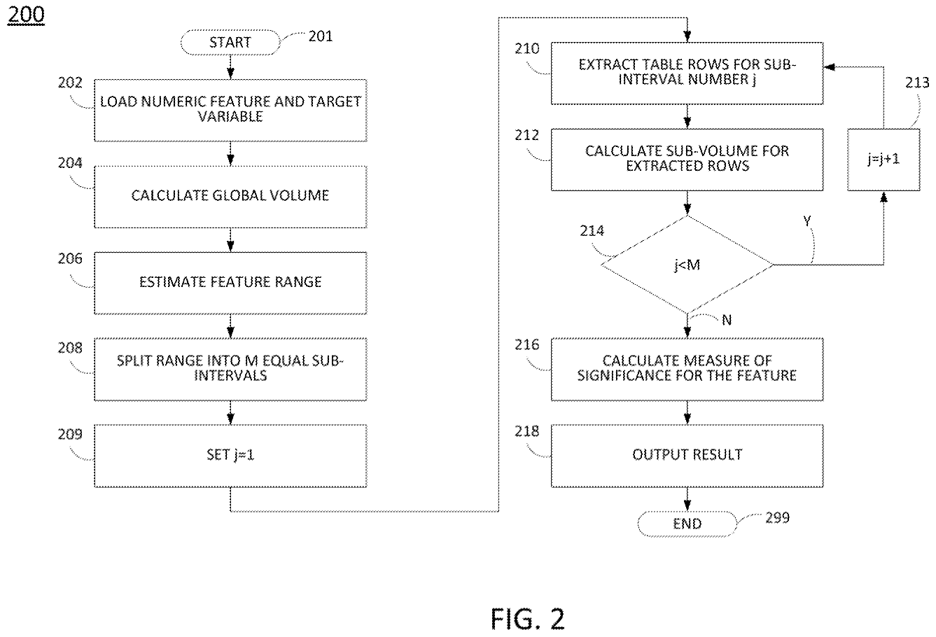

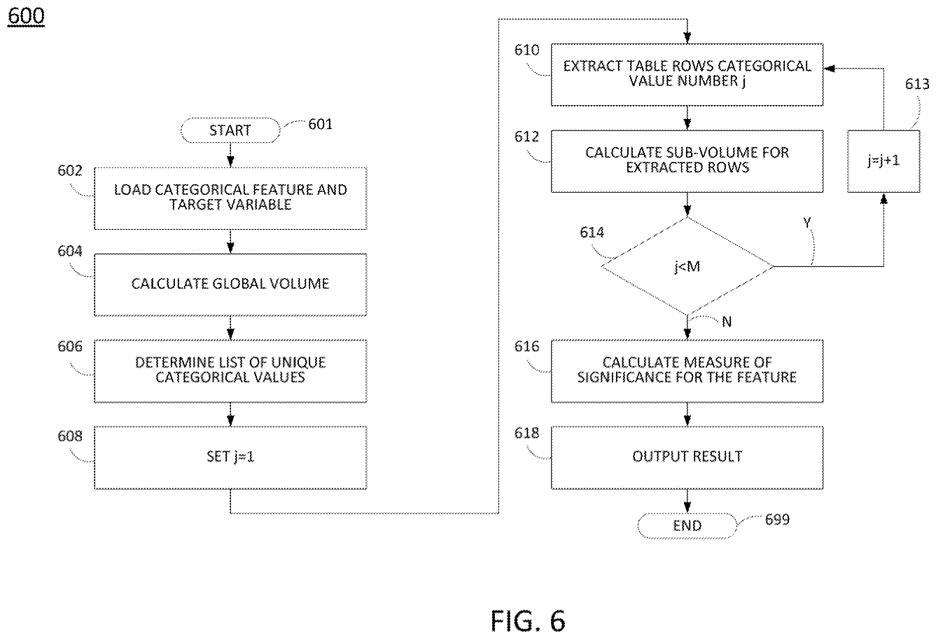

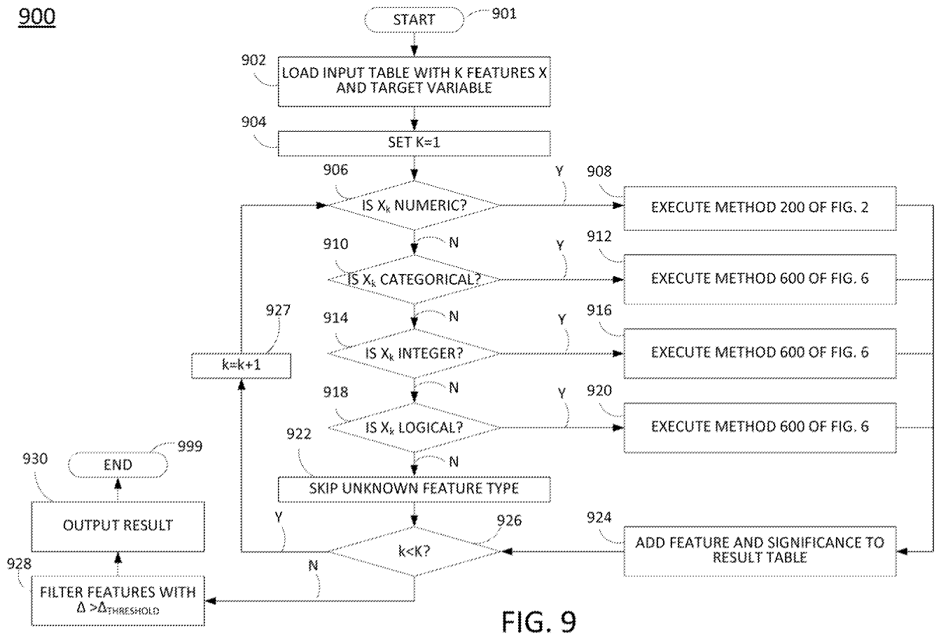

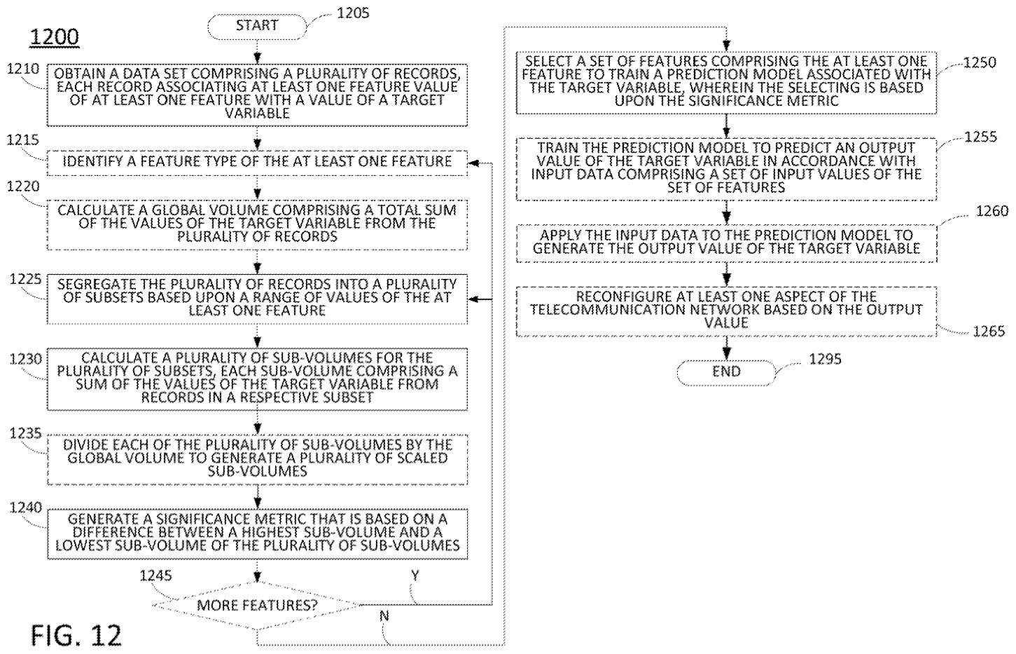

In the example of FIG. 1, service network 130 may include one or more servers 135 which may each comprise all or a portion of a computing device or processing system, such as computing system 1300, and/or a hardware processor element 1302 as described in connection with FIG. 13 below, specifically configured to perform various steps, functions, and/or operations for selecting a feature to train a classification model associated with a target variable based upon a significance metric that is based on a difference between a highest sub-volume and a lowest sub-volume for subsets of records of a data set including feature values of the feature, as described herein. For example, one of the server(s) 135, or a plurality of servers 135 collectively, may perform operations in connection with the example method 200 of FIG. 2, the example method 600 of FIG. 6, the example method 900 of FIG. 9, and/or the example method 1200 of FIG. 12, or as otherwise described herein. In one example, the one or more of the servers 135 may comprise an artificial intelligence (AI)/machine learning (ML)-based service platform (e.g., a network-based and/or cloud-based service hosted on the hardware of servers 135).

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 13 and discussed below) or multiple computing devices collectively configured to perform various steps, functions, and/or operations in accordance with the present disclosure.

In one example, service network 130 may also include one or more databases (DBs) 136, e.g., physical storage devices integrated with server(s) 135 (e.g., database servers), attached or coupled to the server(s) 135, and/or in remote communication with server(s) 135 to store various types of information in support of systems for selecting a feature to train a classification model associated with a target variable based upon a significance metric that is based on a difference between a highest sub-volume and a lowest sub-volume for subsets of records of a data set including feature values of the feature, as described herein. As just one example, DB(s) 136 may be configured to receive and store network operational data collected from the telecommunication service provider network 150, such as call logs, mobile device location data, control plane signaling and/or session management messages, data traffic volume records, call detail records (CDRs), message detail records (e.g., regarding SMS or MMS messages), error reports, network impairment records, performance logs, alarm data, and other information and statistics, which may then be compiled and processed, e.g., normalized, transformed, tagged, etc., and forwarded to DB(s) 136, via one or more of the servers 135. In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like.

In one example, DB(s) 136 may be configured to receive and store records from customer, user, and/or subscriber interactions, e.g., with customer facing automated systems and/or personnel of a telecommunication network service provider (e.g., the operator of telecommunication service provider network 150). For instance, DB(s) 136 may maintain call logs and information relating to customer communications which may be handled by customer agents via one or more of the devices 131-134. For instance, the communications may comprise voice calls, online chats, emails, etc., and may be received by customer agents at devices 131-134 from one or more of devices 111-113, 121-123, etc. The records may include the times of such communications, the start and end times and/or durations of such communications, the touchpoints traversed in a customer service flow, results of customer surveys following such communications, any items or services purchased, the number of communications from each user, the type(s) of device(s) from which such communications are initiated, the phone number(s), IP address(es), etc. associated with the customer communications, the issue or issues for which each communication was made, etc. Alternatively, or in addition, any one or more of devices 131-134 may comprise an interactive voice response system (IVR) system, a web server providing automated customer service functions to subscribers, etc. In such case, DB(s) 136 may similarly maintain records of customer, user, and/or subscriber interactions with such automated systems. The records may be of the same or a similar nature as any records that may be stored regarding communications that are handled by a live agent.

Similarly, any one or more of devices 131-134 may comprise a device deployed at a retail location that may service live/in-person customers. In such case, the one or more devices 131-134 may generate records that may be forwarded and stored by DB(s) 136. The records may comprise purchase data, information entered by employees regarding inventory, customer interactions, surveys responses, the nature of customer visits, etc., coupons, promotions, or discounts utilized, and so forth. In this regard, any one or more of devices 111-113 or 121-123 may comprise a device deployed at a retail location that may service live/in-person customers and that may generate and forward customer interaction records to DB(s) 136. For instance, such a device (e.g., a “personnel device”) may comprise a tablet computer in which a retail sales associate may input information regarding a customer and details of the transaction, such as identity and contact information provided by the customer (e.g., a name, phone number, email address, mailing address, etc.), desired items (e.g., physical items, such as smart phones, phone cases, routers, tablet computers, laptop computers, etc., or service items, such as a new subscription or a subscription renewal, a type of subscription (e.g., prepaid, non-prepaid, etc.), an agreement duration (e.g., a one-year contract, a two-year contract, etc.), add-on services (such as additional data allowances, international calling plans, and so forth), discounts to be applied (such as free phone upgrades and/or subsidized phone upgrades, special group discounts, etc.), and so on. In such case, information entered and/or obtained via such personnel devices may be forwarded to server(s) 135 and/or DB(s) 136 for processing and/or storage. As such, DB(s) 136, and/or server(s) 135 in conjunction with DB(s) 136, may comprise a retail inventory management knowledge base. In addition, DB(s) 136 and/or server(s) 135 in conjunction with DB(s) 136 may comprise an account management system. For instance, information regarding subscribers' online and in-store activities may also be included in subscriber account records (e.g., in addition to contact information, payment information, information on current subscriptions, authorized users, duration of contract, etc.).

In one example, DB(s) 136 may alternatively or additionally receive and store data from one or more third parties. For example, one or more of the endpoint devices 111-113 and/or 121-123 may represent a server, or servers, of a consumer credit entity (e.g., a credit bureau, a credit card company, etc.), a merchant, or the like. In such an example, DB(s) 136 may obtain one or more data sets/data feeds comprising information such as: consumer credit scores, credit reports, purchasing information and/or credit card payment information, credit card usage location information, and so forth. In one example, one or more of endpoint devices 111-113 and/or 121-123 may represent a server, or servers, of an email service provider, from which DB(s) 136 may obtain email address service information (e.g., high-level information, such as the date that the email address was created and/or an age or approximate age of the email address since it was created, a mailing address and/or phone number (if any) that is associated with the email address (and if the third party is permitted to provide such information in accordance with the email address owner's permissions). Such information may then be leveraged in connection with email addresses that may be provided by customers during in-person transactions at telecommunication network service provider retail locations. Similarly, one or more of the endpoint devices 111-113 and/or 121-123 may represent a server, or servers, of one or more merchants or other entities (such as entities providing ticketed sporting events and/or concerts, email mailing lists, etc.), from which DB(s) 136 may obtain additional email address information (e.g., email address utilization information).

In one example, DB(s) 136 may store any or all of the above types of information and/or other information that may be used for classification tasks as sets of predictor feature values and target feature values. For instance, sets may be implemented as rows in a table that associates predictor features values and target feature values. It should be noted that the foregoing is illustrative of just several examples of the type of data that may be used as predictors for various binary classification tasks (e.g., prediction, detection, etc.) and that various additional types of data may be used for the same or different classification tasks. For instance, DB(s) 136 may store historical weather data values as additional factors that may be associated with a classification tasks relating to forecasting whether or not a network element may be overloaded. For instance, when a storm is approaching, network activity may significantly increase, and may make overloading of a network element more likely. Alternatively, or in addition, weather data may be used for classification, forecasting, or the like relating to prediction of whether vehicular traffic on a roadway 30 minutes from a present time may exceed a threshold (e.g., will traffic cause more than 5 minutes of delay or not on highway X?). Various other examples may relate to additional types of data/predictors and different prediction tasks for various domains.

In one example, DB(s) 136 may store various detection/prediction models (e.g., AI/ML-based prediction models) for various tasks. For instance, a binary classification model may be trained to determine whether a telephone number, customer account, device, user identifier, etc. is associated with robocalling activity (or not), churn (e.g., will a customer/telephone number continue to be a subscriber (or not) at a future time), fraud, botnet activity, Short Message Service/SMS or text spam, etc. Alternatively, or in addition, a classification model may be trained to predict whether a particular network equipment (e.g., a router, a base station and/or a baseband unit, a server, and so forth) or a network link will fail, become overloaded, or the like.

It should be noted that as referred to herein, a classification model (broadly including models for prediction, classification, forecasting, and/or detection) may include a machine learning model (MLM) (or machine learning-based model), e.g., a machine learning algorithm (MLA) that has been “trained” or configured in accordance with input data (e.g., training data) to perform a particular service, e.g., to detect whether a phone number is or is not associated with robocalling activity, to predict fraud and/or to provide a fraud indicator, to detect a likely failure or overload of a network element, and so forth. Examples of the present disclosure may incorporate various types of MLAs/models that utilize training data, such as support vector machines (SVMs), e.g., linear or non-linear binary classifiers, multi-class classifiers, deep learning algorithms/models, such as deep learning neural networks or deep neural networks (DNNs), generative adversarial networks (GANs), decision tree algorithms/models, k-nearest neighbor (KNN) clustering algorithms/models, and so forth. In accordance with the present disclosure, an MLA and associated MLM may provide a binary prediction (e.g., the dependent variable may take one of two possible values). In addition, it should be noted that although examples of the present disclosure are described herein primarily in connection with binary classification tasks (e.g., a binary target/dependent variable), in other, further, and different examples, the present disclosure may provide for feature selection for a ternary classification task, a quaternary classification task, or the like (e.g., for a ternary target/dependent variable, a quaternary target variable, or a target variable with a similar discrete set of possible values, etc.). In other words, the MLA and associated MLM may provide a classification/prediction from among three categories, four categories, etc.

In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. In one example, MLAs/MLMs of the present disclosure may be in accordance with an open source library, such as OpenCV, which may be further enhanced with domain specific training data. In one example, records in DB(s) 136 may thus be used as training data and/or testing data to train and verify the accuracy of a classification model for churn prediction, robocalling detection, and/or classification, for fraud detection, and so forth (broadly, a “network activity detection machine learning model”) as described herein.

Operations of server(s) 135 for selecting a feature to train a prediction model associated with a target variable based upon a significance metric that is based on a difference between a highest sub-volume and a lowest sub-volume for subsets of records of a data set including feature values of the feature, and/or server(s) 135 in conjunction with one or more other devices or systems (such as DB(s) 136) are further described below in connection with the examples of FIGS. 2-13. In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of server(s) 135 and DB(s) 136 may be distributed at different locations, such as in or connected to access networks 110 and 120, in another service network connected to Internet 160 (e.g., a cloud computing provider), in telecommunication service provider network 150, and so forth.

In addition, it should be understood that other aspects of the system 100 may be omitted from illustration in FIG. 1. As just one example, the system 100 may include a data distribution platform such as Apache Kafka, or the like, for obtaining sets/streams of data from telecommunication network service provider data source(s) (e.g., server(s) 155, devices 131-134, or the like) and third party data source(s) (e.g., endpoint devices 111-113, endpoint devices 121-123, or the like). The system 100 may also incorporate in-stream processing, such as preprocessing of raw data for ingestion into a database stored by DB(s) 136 and/or for input into a classification model via server(s) 135. For example, the server(s) 135 and/or DB(s) 136, as well as upstream data sources, may be deployed on one or more instances of Apache Flink, or the like, as part of and/or in association with the Kafka streaming platform. In addition, the classification model(s), the feature selection processes, and so forth may be trained within and/or may operate on such a platform. For instance, the server(s) 135 and/or DB(s) 136 may comprise an instance of Apache Spark, e.g., on top of Hive and Hadoop Distributed File System (HDFS), or similar arrangement. Thus, these and other aspects are all contemplated within the scope of the present disclosure.

Definitions—In machine learning, feature selection is the process of selecting a subset of relevant features (variables, predictors) for use in model construction. Thus, relevant features should have a causal relationship with a target variable—if the feature value is changed, then the target variable value should be changed as well. In one example, it may be desirable that a feature significance measure is proportional to the impact on the target variable. For instance, for a significance (or impact) measure Δ, the impact of an irrelevant feature may be Δ=0, and the impact of a relevant feature may be Δ<<0; Δε[0;1]. In one example, the present disclosure may assume the following definitions:
(1) There is a table T which includes target variable Y and K features Xₖ, k=1, . . . K; the table has n rows: T={Yᵢ; Xₖᵢ}, k=1, . . . , K; i=1, . . . , N where Y is the target variable having binary values and Xₖ feature variables, which have numerical or categorical values.
(2) I is a complete set of row indexes of the table T: I={1, 2, . . . , N}.
(3) I can be represented by a set of non-intersecting subsets: I=I₁∪I₂ . . . ∪I_{M}.
(4) Global volume is the sum of all target variable values: V=Σ_{i∈I}Yᵢ.
(5) Sub-volume is the sum of all target variable values belonging to a particular subset: Vₖ=Σ_{i∈I}_{ₖ}Yᵢ, =1, . . . , M.
(6) Global volume can also be represented by the following formula: V=Σⱼ₌₁^{M}Vₖ.
(7) The ratio

$${R}_{k} = \frac{{V}_{j}}{V}$$

represents a percent of the global volume which is associated with subset Iⱼ.

Based on the definitions (1)-(7), a process of the present disclosure may be described by the following representative steps, functions, and/or operations:
(1) Load input table T with binary target variable Y={Yᵢ}, i=1, . . . , N and K features Xₖ={Xₖᵢ}, i=1, . . . , N; k=1, . . . , K.
(2) Calculate global volume V=Σ_{i∈I}Yᵢ, I={1, . . . , N}.
(3) Set k=1.
(4) Estimate a range of the feature Xₖ, which can be either: a list of a categorical feature values Rₖ={c₁, . . . , c_{L}}, where M is a count of the categorical feature values, or a range of a numeric feature

$${R}_{k} = [ {max}_{i} {X}_{{k}_{i = 1}}^{N} - {min}_{i} {X}_{{k}_{i = 1}}^{N} ] .$$

(5) Split the range Rₖ into a set of M non-intersecting sub-intervals rₖⱼ: Rₖ=∪ⱼ^{M} rₖⱼ in such a way that all values of the feature Xₖ are equally represented by sub-intervals rₖⱼ, j=1, . . . , M.
(6) Set j=1.
(7) Determine a set of row indexes Iⱼ∈I in the table T for sub-interval rₖⱼ.
(8) Calculate sub-volume Vⱼ={Σ_{i∈I}_{ⱼ}Yᵢ} and divide it by the global volume: Vⱼ=Vⱼ/V.
(9) If j<M then j=j+1; go to step (5).
(10) Calculate the measure of significance for the feature k: Δₖ=[max(Vⱼ₌₁^{M})−min(Vⱼ₌₁^{M})].
(11) If k<K then k=k+1; go to step (4).
(12) Filter features with significance Δ>Δ_{threshold}; use the features to build a predictive model.

Notably, in one example, dividing sub-volumes by global volume at step 8 may be performed for normalization, which guarantees a feature significance value within a [0;1] interval. However, in another example, the above process may be employed without such normalization. In such case, a sub-volume may show how many times class 1 in the binary classification task has occurred over a current sub-interval. The above process may work in the same way for numeric and categorical features except step 4, which may instead (a) split a numerical feature range into a set of equal sub-intervals and calculate sub-volume for each sub-interval, or (b) determine a list of unique categories for a categorical feature (which may also be referred to as sub-intervals) and calculate sub-volume for each category. In one embodiment, feature range can be an important aspect of the above process, which determines how the volume is distributed over the range, and which estimates the feature impact on the target variable based on the distribution. For instance, a feature range includes all values of a feature. For a numeric feature, all values are contained between maximum and minimum feature values because a numeric feature is an ordered set of data. A numeric range can be split into a set of non-intersecting sub-intervals. A sub-volume calculated for each sub-interval represents distribution of the volume over the range. On the other hand, a categorical feature is an unordered set of labels. Thus, it may not be possible to estimate minimum and maximum values. In this case, the feature range may be represented by a list of unique categorical feature values. To find a volume distribution over such range, sub-volume is calculated for each element in the list.

Feature Significance Estimation for Numeric Features—A more detailed description of estimating feature significance of a numeric feature is characterized as follows. In one example, the following process may be used as a module in a more general process that processes multiple features having numeric, categorical, or other feature types.
(1) Load input table T with two variables: binary target variable Y={yᵢ}, i=1, . . . , N and numeric feature X={xᵢ}, i=1, . . . , N.
(2) Calculate global volume V=Σ_{i∈I}yᵢ, I={1, . . . , N}.
(3) Estimate range

$$R = [ {max}_{i} {X}_{i = 1}^{N} - {min}_{i} {X}_{i = 1}^{N} ]$$

of the feature X.
(4) Split the range R into a set of M equal non-intersecting sub-intervals rₖⱼ: R=∪ⱼ^{M}rⱼ.
(5) Set j=1.
(6) Determine a set of row indexes Iⱼ∈I in the table T for sub-interval rⱼ.
(7) Calculate a sub-volume Vⱼ={Σ_{i∈I}Yᵢ} and divide by the global volume: Vⱼ=Vⱼ/V.
(8) If j<M then j=j+1; Go to step (6).
(9) Calculate the measure of significance for the feature X:

$$Δ = [ {max}_{j} {V}_{j = 1}^{M} - {min}_{j} {V}_{j = 1}^{M} ] .$$

FIG. 2 illustrates an example flowchart of a method 200 for significance estimation of a numeric feature. In one example, steps, functions, and/or operations of the method 200 may be performed by a processing system comprising one or more devices as illustrated in FIG. 1, e.g., one or more of servers 135, one or more of servers 135 in conjunction with one or more other devices, such as server(s) 155, other components of telecommunication service provider network 150 and/or access networks 110 and/or 120, and so forth. Alternatively, or in addition, the method 200 may be implemented by a computing device or processing system such as illustrated in FIG. 13 and described below, or multiple instances of such a computing device (e.g., a processing system comprising multiple component devices). Method 200 is intended to estimate significance for a single numeric feature and can be used (called) from another method illustrated in FIG. 9, which processes a list of features that may include different types of features.

The input data may comprise a table T that includes two variables: a numeric feature X={xᵢ}, i=1, . . . , N and a target variable Y={yᵢ}, i=1, . . . , N. The target variable is binary (e.g., with values 1 or 0). N is the number of rows in the input table. The method 200 begins at step 210 and proceeds to step 202 comprising loading a numeric feature and the target variable. Next, at step 204, the global volume may be calculated, which is a sum of all target variable values: V=Σ_{i∈I}yᵢ, I={1, . . . , N}. The global volume V may be used in a subsequent step to normalize an estimated feature significance value. At step 206, the numeric feature range may be estimated as a difference between maximum and minimum values of the feature:

$$R = [ {max}_{i} {X}_{i = 1}^{N} - {min}_{i} {X}_{i = 1}^{N} ] .$$

At step 208, the range R may be split into M equal sub-intervals. For instance, if the range R=[0; 5], and M=5, then the following 5 sub-intervals may be created: r₁=[0;1]; r₂=[1; 2]; r₃=[2; 3]; r₄=[3; 4]; r₅₁=[4; 5]. The number of sub-intervals M may be a selectable/tunable parameter of the method 200, which in one example can be determined based on the data volume N. For instance, when the input table is split by sub-intervals of a feature, it may be preferred to have enough data points in each sub-interval. On the other hand, it may also be desirable to have more detailed information about each feature, which requires a larger number of sub-intervals. Thus, M may be selected for either of these objectives, or to balance these objectives. For example, if there are millions of records in the input table, then the number of sub-intervals may be set at M=50-100. If there are hundreds of thousands rows in the table, then M=20-30 may be more appropriate. Similarly, for several thousand records, M=5-10 may be more optimal so as to reduce the likelihood of a sub-interval having no data points.

At step 209 the sub-interval index j may be set to 1. Further, at step 210, records from the table T satisfying the condition X∈r; (which is equivalent to the condition (X≥0) & (X<1)) may be extracted. In this way all row indexes Iⱼ∈I in the table T satisfying the condition X∈rⱼ are determined. At step 212, a sub-volume for the extracted rows may be calculated: Vⱼ={Σ_{i∈I}_{ⱼ} yᵢ}/V. At step 214 the condition j<M is checked. If the condition is satisfied, then the current number of a sub-interval is incremented at step 213 (j=j+1) and the method 200 returns to step 210. If j<M is not satisfied, then sub-volumes for all sub-intervals have been estimated and the method 200 may proceed to step 216. At step 216, the measure of significance for the feature X may be calculated:

$$Δ = [ {max}_{j} {V}_{j = 1}^{M} - {min}_{j} {V}_{j = 1}^{M} ] .$$

Lastly, at step 218 the measure of significance for the feature X may be output. Following step 218, the method 200 may proceed to step 299 where the method 200 ends.

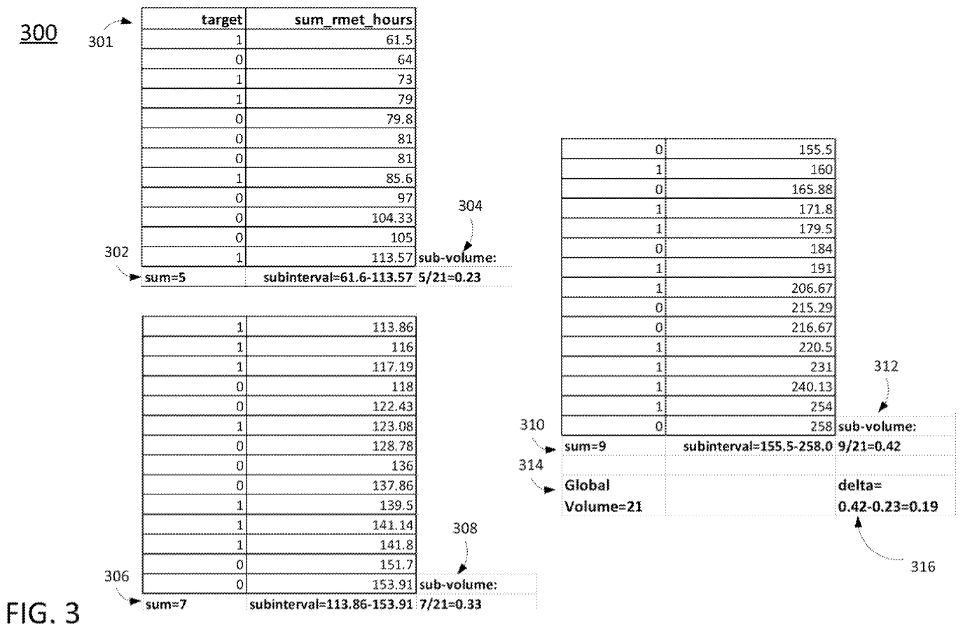

FIG. 3 illustrates the performance of calculations according to the example method 200 of FIG. 2 for a particular example included in the table 300. For instance, at 314 the global volume may be calculated as a total sum of the instances of the target variable: V=21. At 301, “target” is the target variable and “sum_rmet_hours” is a numeric feature. The input table T in the method 200 of FIG. 2 may be comprised of these two variables. Accordingly, the table may be sorted by the values of the numeric feature. In addition, the range may be identified: R=[61.5; 258.0]. For simplicity and ease of illustration, in the example of FIG. 3, the range is split into three sub-intervals: r₁=[61.5; 113.57]; r₂=[113.86; 153.91]; r₃=[155.5; 258.0]. However, it should be understood that in other, further, and different examples, a larger number of sub-intervals may be utilized (or less, in the case of a binary predictor variable). It should also be noted that for ease of illustration, the table 300 has been split into three sub-sections corresponding to the three sub-intervals. In other words, these are not necessarily separate tables, but are all part of the same table 300. At 302, 306, and 310, the sum of binary target values may be calculated for each subinterval. Further, at 304, a sub-volume for sub-interval r₁ may calculated, e.g.:

$${V}_{1} = \frac{5}{21} = 0.213 .$$

At 308, a sub-volume for sub-interval r₂ may be similarly calculated:

$${V}_{2} = \frac{7}{21} = 0.33 .$$

In addition, at 312, a sub-volume for sub-interval r₃ may be calculated, e.g.:

$${V}_{3} = \frac{9}{21} = 0.42 .$$

Notably, the measure of significance for the feature “sum_rmet_hours” may be calculated at 316 as a difference between the maximum and minimum sub-volumes: delta=0.42−0.23=0.19.

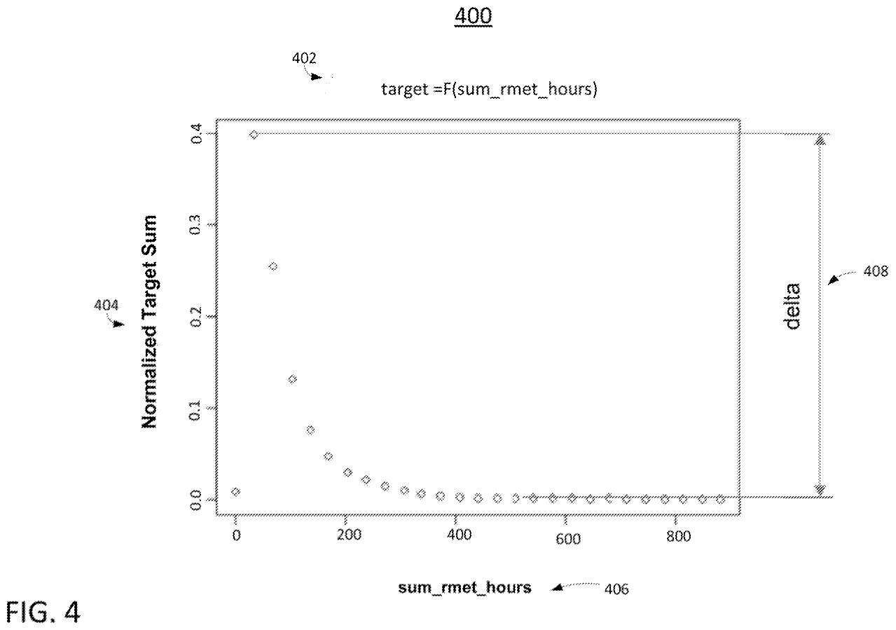

FIG. 4 illustrates a graph 400 of normalized target sums for feature sub-intervals for the same or similar example as FIG. 3, but with a more practical number of sub-intervals M=30. As in the previous example, the target variable is a function of the feature sum_rmet_hours (e.g., target=F (sum_rmet_hours)). At 402 the target variable name is presented: target. At 406 the feature name sum_rmet_hours is used as horizontal axis name. The feature range is equal to 900. The graph 400 illustrates that the feature range is split into set of 30 equal sub-intervals (M=30). At 404, the graph shows that vertical axis on the diagram is the ratio of sub-volume and global volume: Vⱼ/V. The dots on the graph 400 illustrate distribution of the ratio over the sum_rmet_hours feature range R=[0; 900]. At 408, the graph shows how to determine the measure of the feature significance, which is the difference between maximum and minimum values:

$$delta = [ {max}_{j} {V}_{j = 1}^{M} - {min}_{j} {V}_{j = 1}^{M} ] .$$

Sub-volume is a sum of all target variable values for rows belonging to a particular sub-interval and the normalized target sum for a sub-interval is dependent of the sub-volume. Thus, the curve reflects how the target variable is dependent on the feature. For instance, a maximum of the target variable corresponds with low values of the variable sum_rmet_hours. In other words, low values of the feature sum_rmet_hours corresponded with high values of the target variable. In addition to the feature significance estimation, the graph 400 also enables visualizing the dependency target=F(feature), and creates new opportunities to learn and interpret dependencies between a target variable and each feature.

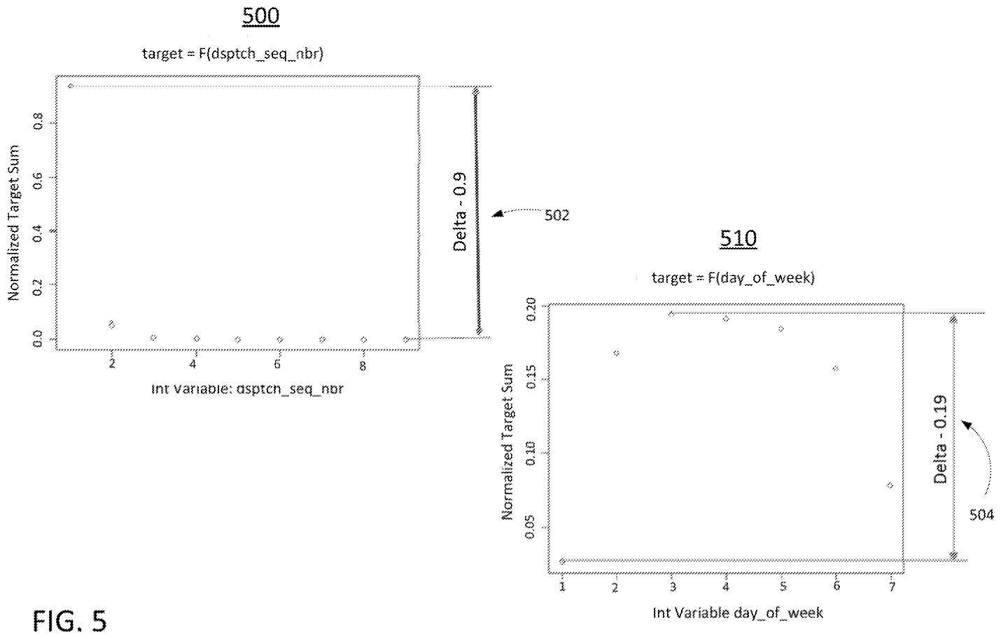

To further aid in understanding the present disclosure, FIG. 5 compares the significance of two features day_of_week (delta=0.19) at 502 of graph 500 and dsptch_seq_nbr (delta=0.90) at 504 of graph 510. Notably, the significance of the feature dsptch_seq_nbr is much higher compared with the significance of day_of_week.

Feature Significance Estimation for Categorical Features—A more detailed description of estimating feature significance of a categorical feature is characterized as follows. In one example, the following process may be used as a module in a more general process that processes multiple features having numeric, categorical, or other feature types.
(1) Load input table T with two variables: binary target variable Y={yᵢ}, i=1, . . . , N and categorical feature X={xᵢ}, i=1, . . . , N.
(2) Calculate global volume V=Σ_{i∈I}yᵢ, I={1, . . . , N}.
(3) Determine list of unique categorical values {xⱼ}, i=1, . . . , M.
(4) Set j=1.
(5) Determine a set of row indexes Iⱼ∈I in the table T for all rows with X=xⱼ.
(6) Calculate a sub-volume Vⱼ={Σ_{i∈I}, Yᵢ} and divide by the global volume: Vⱼ=Vⱼ/V.
(7) If j<M then j=j+1; Go to step (5).
(8) Calculate the measure of significance for the feature X:

$$Δ = [ {max}_{j} {V}_{j = 1}^{M} - {min}_{j} {V}_{j = 1}^{M} ] .$$

FIG. 6 illustrates an example flowchart of a method 600 for significance estimation of a categorical feature. In one example, steps, functions, and/or operations of the method 600 may be performed by a processing system comprising one or more devices as illustrated in FIG. 1, e.g., one or more of servers 135, one or more of servers 135 in conjunction with one or more other devices, such as server(s) 155, other components of telecommunication service provider network 150 and/or access networks 110 and/or 120, and so forth. Alternatively, or in addition, the method 600 may be implemented by a computing device or processing system such as illustrated in FIG. 13 and described below, or multiple instances of such a computing device (e.g., a processing system comprising multiple component devices). Method 600 is intended to estimate significance for a single categorical feature and can be used (called) from another method illustrated in FIG. 9, which processes a list of features that may include different types of features.

The input data may comprise a table T that includes two variables: a categorical feature X={xᵢ}, i=1, . . . , N and a target variable Y={yᵢ}, i=1, . . . , N. The target variable can be numeric or binary (e.g., with values 1 or 0). N is the number of rows in the input table. The method 600 begins at step 601 and proceeds to step 602 comprising loading a categorical feature and the target variable. Next, at step 604, the global volume may calculated, which is a sum of all target variable values: V=Σ_{i∈I}yᵢ, I={1, . . . , N}. The global volume V may be used in subsequent step 612 to normalize an estimated feature significance value. At step 606, a list of unique categorical values {xⱼ}, i=1, . . . , M may be determined. At step 608, the categorical value index j may be set to 1. Furthermore, at step 610, records from the table T satisfying the condition X=xⱼ, which includes all rows from the table T with the category value equal to xⱼ, may be extracted. In this way all row indexes Iⱼ∈I in the table T satisfying the condition X=xⱼ are determined. At step 612, a sub-volume for the extracted rows may be calculated: Vⱼ={Σ_{i∈I}; yᵢ}/V. At step 614, the condition j<M is checked. If the condition is satisfied, then the current category index is incremented: j=j+1 and the method 600 may return to step 610. If the condition is not satisfied, then sub-volumes for all categories have been estimated and the method may proceed to step 616. At step 616, the measure of significance for the categorical feature X may be calculated:

$$Δ = [ {max}_{j} {V}_{j = 1}^{M} - {min}_{j} {V}_{j = 1}^{M} ] .$$

Lastly, at step 618 the measure of significance for the feature X may be output. Following step 618, the method 600 may proceed to step 699 where the method 600 ends.

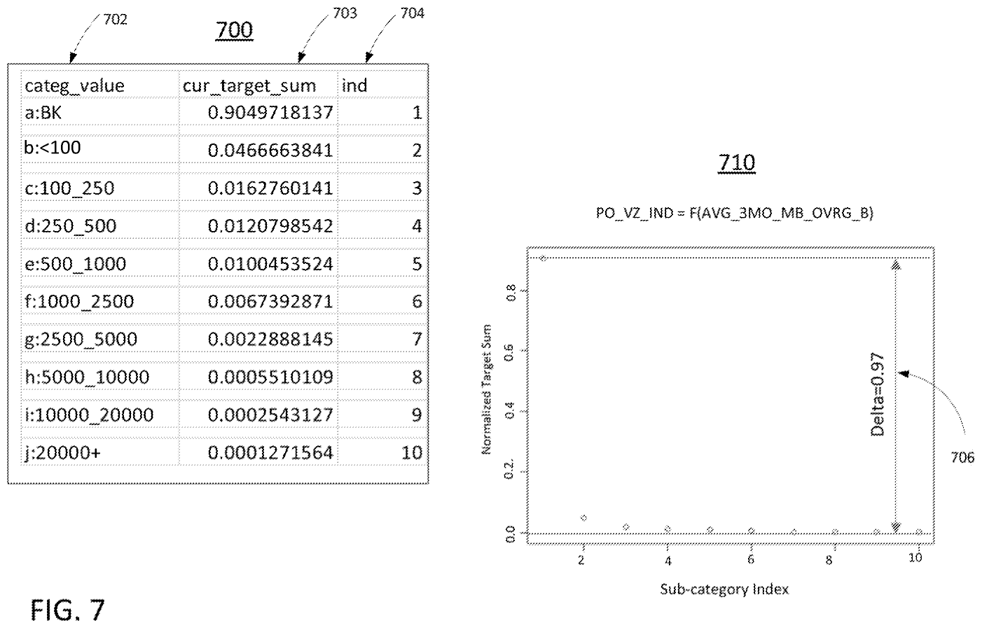

FIG. 7 illustrates example results of feature significance estimation for a categorical feature which has ten unique categorical values represented at 702 in the column categ_value of table 700. Column cur_target_sum at 703 shows a sub-volume for each categorical value. Column ind at 704 shows the order number for the categ_value. The graph 710 visualizes the relationship between columns 703 and 704, and shows the degree of significance of the feature AVG_3MO_OVRG_B with respect to the target variable PO_VZ_IND that is determined at 706: delta=0.97.

Feature Significance Estimation for Integer Features—A more detailed description of estimating feature significance of an integer feature is characterized as follows. In one example, the following process may be used as a module in a more general process that processes multiple features having numeric, categorical, or other feature types.
(1) Load input table T with two variables: binary target variable Y={yᵢ}, i=1, . . . , N and integer feature X={xᵢ}, i=1, . . . , N.
(2) Calculate global volume V=Σ_{i∈I}yᵢ, I={1, . . . , N}.
(3) Determine list of unique integer values {xⱼ}, i=1, . . . , M.
(4) Set j=1.
(5) Determine a set of row indexes Iⱼ∈I in the table T for all rows with X=xⱼ.
(6) Calculate sub-volume vⱼ={Σ_{i∈I}Yᵢ} and divide by the global volume: Vⱼ=Vⱼ/V.
(7) If j<M then j=j+1; Go to step (5).
(8) Calculate the measure of significance for the feature X:

$$Δ = [ {max}_{j} {V}_{j = 1}^{M} - {min}_{j} {V}_{j = 1}^{M} ] .$$

As follows from the above algorithm, it is almost identical compared with significance estimation for categorical features (See, e.g., the flowchart of the example method 600 of FIG. 6). In the case of an integer feature, a list of unique integer values may be determined in the same way as a list of unique categorical values for a categorical feature. Otherwise, the processes are the same.

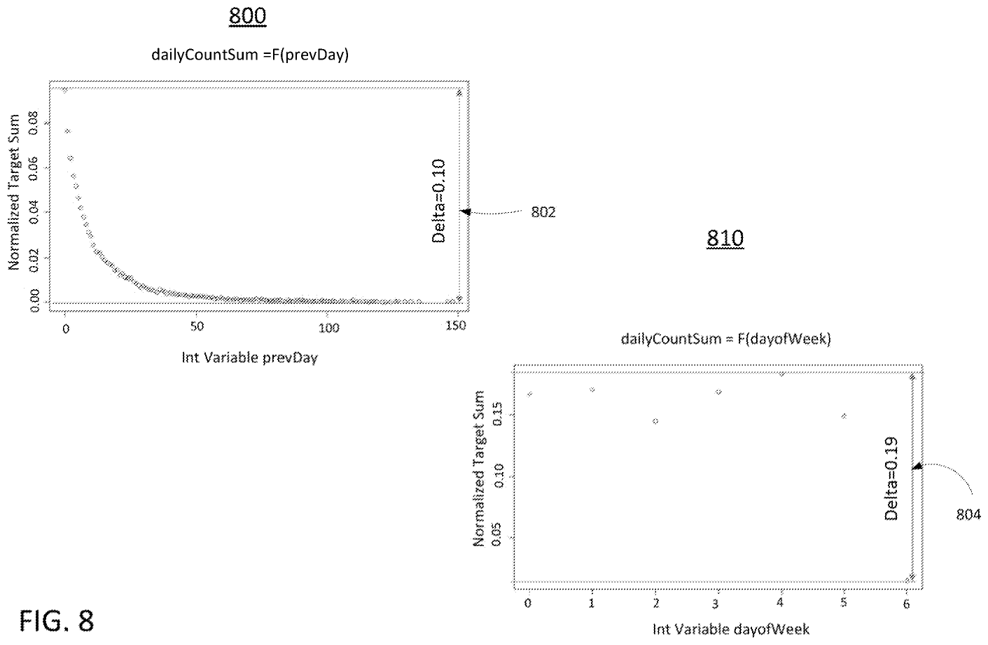

To further aid in understanding the present disclosure, FIG. 8 compares the significance of two integer features prevDay (delta=0.10) at 802 of graph 800 and dayofWeek (delta=0.19) at 804 of graph 810. Notably, the significance of the feature dayofWeek is higher compared with significance of the feature prevDay.

Feature Significance Estimation for Loqical Features—Logical or binary features have just two unique values such as TRUE/FALSE, YES/NO, 1/0, etc. Conceptually, logical and/or binary features can be considered as a special case of categorical features with two unique values. Thus, the feature significance method 600 of FIG. 6 can be used for logical and/or binary features in the same way as for all other categorical features.

Feature Selection for Datasets with Different Types of Features—A more detailed description of an example of selecting features from among a heterogeneous set of features based on feature significance is characterized as follows. For instance, multiple features may be selected from among numeric, categorical, or other feature types as follows:
(1) Load input table T with binary target variable Y={Yᵢ}, i=1, . . . , N and K features Xₖ={Xₖᵢ}, i=1, . . . , N; k=1, . . . , K.
(2) Calculate global volume V=Σ_{i∈I}Yᵢ, I={1, . . . , N}.
(3) Set k=1.
(4) If Xₖ is a numeric feature, then calculate feature significance Δ by method 200 of FIG. 2; else if Xₖ is a categorical feature, integer feature, binary feature, or logical feature, then calculate feature significance Δ by the method 600 of FIG. 6; else if Xₖ is a feature of unknown type then k=k+1 and go to step (4) for another or next feature.
(5) Add feature name and its significance Δ into a result table Tᵣₑₛ.
(6) If k<K then k=k+1; go to step (4).
(7) Filter the features with significance Δ>Δ_{threshold}.
(8) Use the filtered/selected features to build a model (e.g., a machine learning-based prediction model, detection model, and/or classification model, etc.).

FIG. 9 illustrates an example flowchart of a method 900 for feature selection in the case when multiple features of different types are processed, and the most significant features area selected under a condition that the significance value is above a given threshold value. In one example, steps, functions, and/or operations of the method 900 may be performed by a processing system comprising one or more devices as illustrated in FIG. 1, e.g., one or more of servers 135, one or more of servers 135 in conjunction with one or more other devices, such as server(s) 155, other components of telecommunication service provider network 150 and/or access networks 110 and/or 120, and so forth. Alternatively, or in addition, the method 900 may be implemented by a computing device or processing system such as illustrated in FIG. 13 and described below, or multiple instances of such a computing device (e.g., a processing system comprising multiple component devices).

In particular, the method 900 may process available features of an input table T in a loop. The method 900 begins in step 901 and proceeds to step 902 where the input table T is loaded with binary target variable Y={Yᵢ}, i=1, . . . , N and K features Xₖ={Xₖᵢ}, i=1, . . . , N; k=1, . . . , K. At step 904, a feature index k is set to 1. Next, a current feature type may be determined (See steps 906, 910, 914, and 918). If a feature type does not belong to the list of supported feature types, then the feature is skipped at 922. An example of unknown feature types can be a column with graphical images, BLOBS, text, etc. Otherwise, an appropriate feature significance estimator is called, e.g., in accordance with the method 200 of FIG. 2 or the method 600 of FIG. 6 (See steps 908, 912, 916, and 920). At step 924, the feature name and its significance value may be added to a result table Tᵣₑₛ. At step 926, it is considered whether k<K, if so then k=k+1 at step 927 and the method 900 may return to step 906, et seq. Otherwise, the method 900 may proceed to step 928. At step 928, after the features have been processed and significance estimated, the features with significance Δ>Δ_{threshold} may be filtered/selected. At step 930, the selected features may be output. Following step 930, the method 900 proceeds to step 999 where the method 900 ends.

Feature Selection for Binary Classification—To further illustrate aspects of the present disclosure, an example of a binary classification task comprising churn prediction is described. In particular, in an illustrative example, a balanced input dataset may comprise a binary target variable, 132 categorical and integer features, and 200,000 records, where “balanced” means that the data set includes equal or relatively number of records (e.g., 100,000) for each class. A churn model is a mathematical representation of how churn impacts a telecommunication network. Churn calculations are built on existing data (the number of subscribers leaving service during a given time period). A predictive churn model extrapolates on this data to show future potential churn rates. For such a classification task, the target variable has two classes: 1 (churn happened) and 0 (churn did not happen). Thus, the target variable is binary, and has two possible values. In one example, the impact of each feature on the target variable may be calculated according to the method 200 of FIG. 2 or the method 600 of FIG. 6, as described above. For calculating global volume for a binary target variable (churn/no churn), a sum of all values for the binary target variable may be calculated. It is equivalent to counting the number of occurrences of churn (class 1) because ones and zeros are summarized. Similarly, for each feature, sub-volumes may be calculated for each sub-range (or for each category for categorical, logical, integer, or similar feature).

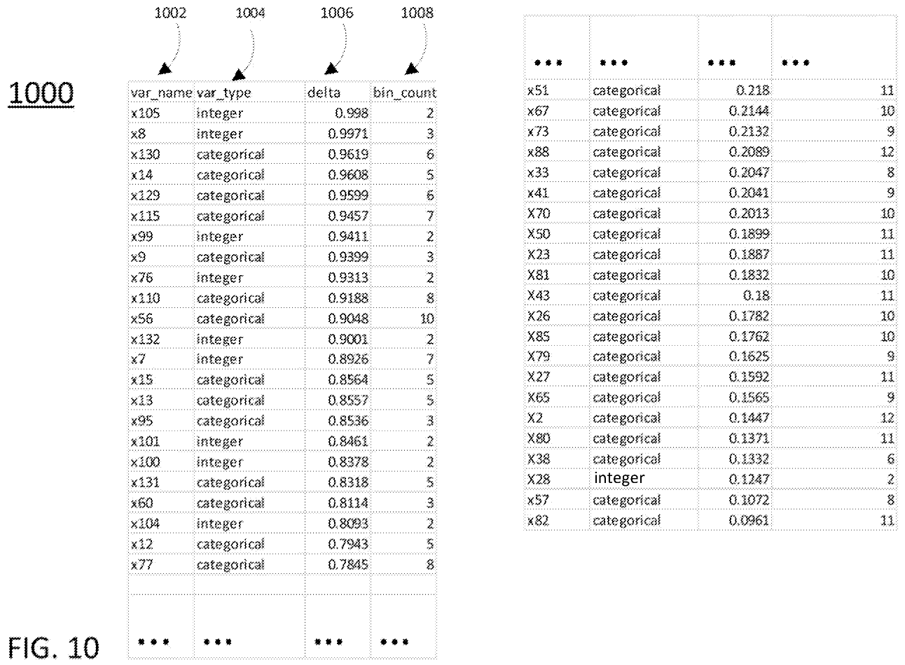

FIG. 10 illustrates comparable significance of categorical and integer features (column delta) impacting a binary target variable for a classification task (e.g., churn) in a table 1000. The original table contains 132 features. However, for ease of illustration, just parts of the features are included in the table 1000 due to space constraints. Notably, the table 1000 is sorted by feature significance delta at 1006. In one example, the most significant features are at the top of the table 1000, and the least significant features are at the bottom of the table 1000. Feature significance may be calculated via the method 900 (and/or the methods 200 and 600, which may be called from the method 900). As illustrated in FIG. 10, column var_name at 1002 shows feature names. Column var_type at 1004 shows feature types such as categorical and integer. Column delta at 1006 shows feature significance. In the present example, feature x105 is the most significant feature with delta=0.998. On the other hand, feature x82 is the least significant feature with delta=0.0961. Column bin_count at 1008 shows the number of unique values for categorical and integer features.

In order to demonstrate efficiency of examples of the present disclosure, two churn classification models were built on the 70 most significant (top) features and on the 70 least significant (bottom) features, and a confusion matrix calculated for each. In addition, the accuracies of the classification models were calculated and compared. In particular, prediction results for a binary classification task may be represented by a confusion matrix, which is a summary of prediction results on a classification problem. The number of correct and incorrect predictions are summarized with count values (or percent values) and broken down by each class.

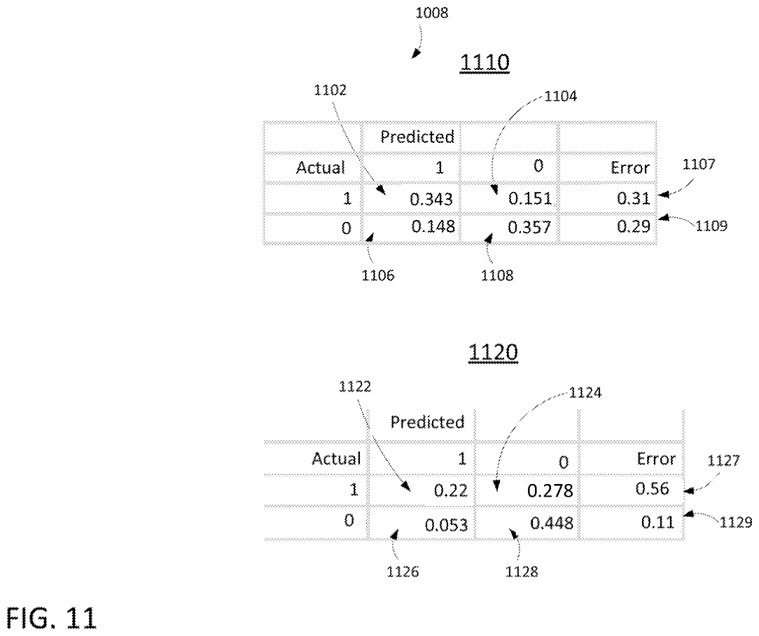

FIG. 11 illustrates confusion matrices 1110 and 1120 in normalized form. For instance, confusion matrix 1110 illustrates classification results for the model built on the 70 most significant features in the table 1000. In particular, the sum of all four matrix cells at 1102, 1104, 1106, and 1108 in the confusion matrix 1110 is 1.00 (with rounding), because the sum represents 100% of the elements in the input dataset including class 1 and class 0. Cell 1102 represents true positives, and shows that 34.3% of cases are predicted as positives (class 1) and are also observed to be positives. Cell 1104 represents false positives, which mean that 15.1% of cases were predicted as positives, but were in fact observed are negatives (class 0). Thus, the error is 31% (see 1107). Cell 1108 represents true negatives: 35.7% of cases are predicted as negatives (class 0), and are also observed to be negatives. Cell 1106 represents false negatives: 14.8% of cases are predicted as negatives (class 0), but in fact are observed as positives (class 1). The error is 29% (see 1109). Confusion matrix 1110 illustrates that the percent of true positives and true negatives are very close to each other, and the error level is almost the same (0.31 and 0.29). This means that the model built on 70 of the most significant features is equally accurate for each of two classes and gives a reliable solution.

Confusion matrix 1120 provides classification results for the model built on the 70 of least significant features in the table 1000. Cell 1122 represents true positives and shows that 22.0% of cases are predicted as positives (class 1), and are also observed to be positives. Cell 1124 represents false positives, which mean that 27.8% of cases are predicted as positives, but in fact are observed to be negatives (class 0). Thus, the error is 56% (see 1127). Cell 1128 represents true negatives: 44.8% of cases are predicted as negatives (class 0), and are observed to be negatives. At 1126 false negatives are presented: 5.3% of cases are predicted as negatives (class 0), but in fact are observed to be positives (class 1). The error is 11% (see at 1129). The confusion matrix 1120 illustrates that the percent of true positives and true negatives are very different, and error levels are imbalanced (0.56 and 0.11). This means that the model built on the 70 least significant features has low overall accuracy, and should not be used for churn prediction. Classification of class 1 (e.g., churn) is incorrect in 56% of cases, which is not acceptable. Use of the most significant features determined in accordance with the present disclosure avoids such an issue, and demonstrates efficient and accurate feature selection.

FIG. 12 illustrates an example flowchart of a method 1200 for selecting a feature to train a classification model associated with a target variable based upon a significance metric that is based on a difference between a highest sub-volume and a lowest sub-volume for subsets of records of a data set including feature values of the feature. In one example, steps, functions, and/or operations of the method 1200 may be performed by a device as illustrated in FIG. 1, e.g., one of servers 135. Alternatively, or in addition, the steps, functions and/or operations of the method 1200 may be performed by a processing system collectively comprising a plurality of devices as illustrated in FIG. 1 such as one or more of server(s) 135, DB(s) 136, endpoint devices 111-113 and/or 121-123, devices 131-134, server(s) 155, and so forth. In one example, the steps, functions, or operations of method 1200 may be performed by a computing device or processing system, such as computing system 1300 and/or a hardware processor element 1302 as described in connection with FIG. 13 below. For instance, the computing system 1300 may represent at least a portion of a platform, a server, a system, and so forth, in accordance with the present disclosure. In one example, the steps, functions, or operations of method 1200 may be performed by a processing system comprising a plurality of such computing devices as represented by the computing system 1300. For illustrative purposes, the method 1200 is described in greater detail below in connection with an example performed by a processing system. The method 1200 begins in step 1205 and may proceed to step 1210.

At step 1210, the processing system obtains a data set comprising a plurality of records, each record of the plurality of records associating at least one feature value of at least one feature with a value of a target variable. In one example, the target variable may comprise a binary variable, e.g., where values of the target variable may have one of two possible values. It should be noted that the present disclosure is not strictly limited to target variables of a declared data type of “binary,” but may include other data types where the values of the data may conform to a binary mathematical representation (e.g., may have a range of two possible values, such as: a variable of a data type of “binary” (e.g., 1/0), a logical variable (e.g., T/F), an integer variable that may have two possible values, a string or char (character) variable that may have two possible values, and so forth. For purposes of the present disclosure, these may all be considered to be examples of a binary target variable. In another example, the target variable may comprise a ternary variable, a quaternary variable, or a variable with a similar discrete set of possible values, etc. In one example, each record may associate a plurality of feature values of a plurality of different features with a value of a target variable.

In accordance with the present disclosure, the data set/plurality of records may comprise telecommunication network operational data and the target variable may comprise a network condition (e.g., in one example, a network condition having two possible states/values). For instance, the telecommunication network operational data may comprise cell radio resource control (RRC) utilization data, physical resource block (PRB) utilization data, etc., control plane signaling and/or session management message volumes, flow records, memory, processor, and/or link utilizations, queue length metrics, network component alarms or alerts (e.g., an alarm for a 70 percent processor utilization threshold being exceeded, an alarm for an 80 percent link utilization being exceeded, etc.), call detail records (CDRs), message detail records (e.g., regarding SMS or MMS messages), error reports, network impairment records, performance logs, and other information and statistics. Similarly, the network condition may comprise: a network state, e.g., a state of at least one network component or network element, such as a network component or link failure (or not), a network component or link reaching a capacity (or not), a network component or link reaching an overload condition (e.g., a 70 percent link utilization threshold being exceeded) (or not), an existence of malicious traffic (or not), such as whether a flow is/is not associated with botnet activity, denial of service activity, etc., or detecting a type of traffic (e.g., that is not necessarily malicious), such as detecting whether traffic is for gaming (or not), video streaming (or not), audio streaming (or not), two way video call (or not), two-way voice call (or not), and so forth.

At optional step 1215, the processing system may identify a feature type of the at least one feature. For instance, the feature type may be numeric (e.g., continuous numeric), integer, binary (e.g., 0/1, logical (e.g., true/false), or the like), categorical, or other. It should be noted that integers, binary variables, and/or logical variables may all be considered as special cases of categorical variables (e.g., where there may be exactly two categories).

At optional step 1220, the processing system may calculate a global volume comprising a total sum of the values of the target variable from the plurality of records. For instance, the global volume may be determined as described above in connection with step 204 of the example method 200 of FIG. 2, step 604 of the example method 600 of FIG. 6, and/or as described elsewhere herein.

At step 1225, the processing system segregates the plurality of records into a plurality of subsets based upon a range of values of the at least one feature. For instance, the range of values when the at least one feature comprises a categorical feature may be the set of possible values that the at least one feature may exhibit (e.g., categories/values that are permitted, acceptable, available, possible, etc. according to definitions of a network operator, device manufacturer, software provider, etc.). When the at least one feature comprises a binary feature, the range may be the two possible values of the binary feature. When the at least one feature comprises an integer feature, the range may be the set of possible integer values that the at least one feature may exhibit (and/or a highest integer value to a lowest integer value of the at least one feature exhibited in the plurality of records in the data set). When the at least one feature comprises a numeric feature, the range may be the set of possible values that the at least one feature may exhibit (and/or a highest value to a lowest value of the at least one feature exhibited in the plurality of records in the data set). In addition, when the at least one feature comprises a numeric feature, step 1225 may include dividing the range into a plurality of sub-intervals, where each of the subsets is defined by a respective sub-interval of the plurality of sub-intervals, and where each of the subsets comprises records of the plurality of records having a respective feature value of the at least one feature that is within the respective sub-interval (e.g., where the plurality of sub-intervals comprises uniform sub-intervals). As described above, the sub-interval size may be selected so as to avoid sub-intervals/subsets having no records, to ensure that each sub-interval/subset has a minimum number of records (e.g., at least five, at least ten, etc.), and so forth.

At step 1230, the processing system calculates a plurality of sub-volumes for the plurality of subsets, each sub-volume of the plurality of sub-volumes comprising a sum of the values of the target variable from records of the plurality of records in a respective subset of the plurality of subsets. For instance, step 1230 may comprise the same or similar operations as described above in connection with step 212 of the example method 200 of FIG. 2, step 612 of the example method 600 of FIG. 6, and/or as described elsewhere herein.

At optional step 1235, the processing system may divide each of the plurality of sub-volumes by the global volume to generate a plurality of scaled sub-volumes. In other words, optional step 1235 may comprise generating a plurality of scaled sub-volumes by dividing each of the plurality of sub-volumes by the global volume (e.g., each scaled sub-volume comprising a normalized sum of the instances of the target variable for each subset). In one example, optional step 1235 may comprise the same or similar operations as described above in connection with step 212 of the example method 200 of FIG. 2, in connection with step 612 of the example method 600 of FIG. 6, or as described elsewhere herein.

At step 1240, the processing system generates a significance metric that is based on a difference between a highest sub-volume and a lowest sub-volume of the plurality of sub-volumes. For instance, in one example, step 1240 may comprise subtracting the lowest sub-volume from the highest sub-volume to provide the significance metric. In another example, step 1240 may comprise subtracting a lowest scaled sub-volume from a highest scaled sub-volume to provide the significance metric falling within the range of zero to one. In one example, step 1240 may comprise the same or similar operations as described above in connection with step 216 of the example method 200 of FIG. 2, in connection with step 616 of the example method 600 of FIG. 6, or as described elsewhere herein.

At optional step 1245, the processing system may determine if there are additional features of the data set to process. For instance, the at least one feature may comprise a first feature of a plurality of features. If so, the method 1200 may return to optional step 1215 or to step 1225. Otherwise, the method 1200 may proceed to step 1250. In this regard, it should be noted that the processing system may repeat various steps of the method 1200 in connection with other features for which a plurality of significance metrics may be calculated (e.g., prior to, following, or contemporaneous with an iteration of steps of the method 1200 in connection with the at least one feature (e.g., a “first” feature). In addition, it should be noted that although a feature may be referred to as “first,” this does not necessarily denote that this is the very first feature for which a significance value is to be calculated with respect to the data set. Rather, the term “first” may be used as a label only to distinguish from a “second” feature, a “third” feature, etc. It should also be noted that in one example, the processing system may not necessarily calculate significance metrics for all of the available features. For instance, some features may be sparsely populated, the processing system may receive a manual indication that certain feature(s) should not be considered for building a classification model, some features may have restrictions on data use which allows the temporary storage of data relating to such feature, but which prevents data of such feature from being used to train/build a classification model, and so forth.

At step 1250, the processing system selects the at least one feature (e.g., at least the first feature) to train a classification model associated with the target variable, wherein the selecting is based upon the significance metric. In one example, step 1250 may comprise selecting a set of features from among the plurality of features, the set of features including the at least one feature. For instance, in one example, the set of features may comprise a defined number of features having the highest significance metrics from among a plurality of significance metrics of the plurality of features. In another example, the set of features may comprise a percentage of a total number of the plurality of features having the highest significance metrics from among a plurality of significance metrics of the plurality of features. In still another example, the set of features may comprise features of the plurality of features having significance metrics above a threshold.

At optional step 1255, the processing system may train the classification model to predict an output value of the target variable in accordance with input data comprising a set of input values of a set of features including the at least one feature. For instance, the classification model may comprise a machine learning-based classification model (e.g., a decision tree, such as gradient boosted decision tree, a binary classifier, such as a support vector machine, a long short-term memory model, a regression model, such as a lasso regression model, ridge regression model, or the like, and so forth), where the selected set of features may comprise predictors/inputs. In one example, the training data set may comprise all or a portion of the plurality of records of the data set. In another example, the training data may comprise different data of the same or a similar nature (e.g., additional records of the data set from one or more subsequent time periods and/or a current time period). In one example, the processing system may extract relevant fields for different records associated with the set of features (and may omit/discard data from fields associated with non-selected features).

At optional step 1260, the processing system may apply the input data to the classification model to generate the output value of the target variable. For instance, after the classification model is trained, at least one set of input data may be applied to the classification model to generate at least one prediction. For example, the at least one prediction may be a prediction, e.g., for a future time period, of whether a network component or link will fail, whether a network component or link will reach a capacity, whether a network component or link will reach an overload condition, whether network traffic, such as a flow, is malicious, whether network traffic (e.g., that is not necessarily malicious), is of a particular type, and so forth.

At optional step 1265, the processing system may reconfigure at least one aspect of the telecommunication network based on the output value. In one example, the reconfiguring may be based on a plurality of output values of the same or a different classification model. For instance, new data may be input to the classification model on an ongoing basis to generate predictions of whether a network element or link may become overloaded. However, if there is only a single output value indicating a predicted overload condition (e.g., outputs/predictions for time periods prior to and after the predicted overload condition indicate that no overload is predicted, then the processing system may ignore or suppress a warning based on the output value. However, if a plurality of output values, such as multiple instances of an output value indicating an overload is predicted (e.g., an output of “1”) over a 10 minute time period, then the confidence of the prediction may increase and the processing system may implement a remedial action accordingly. For instance, the remedial action (e.g., reconfiguring the at least one aspect of the telecommunication network) may comprise configuring at least one network element, such as a firewall, a router, a gateway, or the like to block traffic to or from at least network element or endpoint device, a plurality of network elements or endpoint devices (e.g., devices associated with a botnet activity, devices having excessing network utilization that is most contributory to a likely failure or overload of a network element or link, and so forth).

In one example, the at least one remedial action may alternatively or additionally comprise rate-limiting at least one of network traffic to or from at least network element or endpoint device, imposing selective blocking of connection requests to or from at least one network element or endpoint device, and so forth. Alternatively, or in addition, optional step 1265 may comprise configuring at least one network element to reroute traffic (e.g., all traffic, traffic of a particular category or class, traffic associated with particular endpoint devices and/or endpoint device types, etc.), adding new VNF(s), configuring upstream components to direct less traffic to existing VNF(s) that may be predicted to be overloaded and directing more traffic to new VNF(s), load balancing between database servers, and so forth.

Following step 1250 and/or any of optional steps 1255-1265, the method 1200 may proceed to step 1295. At step 1295, the method 1200 ends.

It should be noted that the method 1200 may be expanded to include additional steps or may be modified to include additional operations with respect to the steps outlined above. For example, the method 1200 may be repeated through various cycles of steps 1215-1245 and/or steps 1225-1245 for additional features, or may be preceded by prior iterations of these steps with respect to one or more other features. In one example, optional step 1220 may precede optional step 1215. In still another example, at least a first iteration of steps 1215-1245 may be performed by a first device or processor, while at least a second iteration of steps 1215-1245 may be performed by a different device or processor. For instance, feature may be processed in parallel to generate a plurality of significance metrics that may then be considered at step 1250. In one example, optional steps 1255, 1260, and/or 1265 may be performed by a different device or processor. For instance, a classification model may be trained via one of server(s) 135 in FIG. 1, while the trained model may be deployed for detection of a network condition and implementation of remedial action(s) on one of the server(s) 155. In one example, the method 1200 may be expanded or modified to include steps, functions, and/or operations, or other features described above in connection with the example(s) of FIGS. 1-11, or as described elsewhere herein. Thus, these and other modifications are all contemplated within the scope of the present disclosure.

In addition, although not specifically specified, one or more steps, functions or operations of the method 1200 may include a storing, displaying and/or outputting step as required for a particular application. In other words, any data, records, fields, and/or intermediate results discussed in the method 1200 can be stored, displayed and/or outputted either on the device executing the method 1200, or to another device, as required for a particular application. Furthermore, steps, blocks, functions, or operations in FIG. 12 that recite a determining operation or involve a decision do not necessarily require that both branches of the determining operation be practiced. In other words, one of the branches of the determining operation can be deemed as an optional step. In addition, one or more steps, blocks, functions, or operations of the above described method 1200 may comprise optional steps, or can be combined, separated, and/or performed in a different order from that described above, without departing from the examples of the present disclosure.

FIG. 13 depicts a high-level block diagram of a computing system 1300 (e.g., a computing device, or processing system) specifically programmed to perform the functions described herein. For example, any one or more components or devices illustrated in FIG. 1, or described in connection with the examples of FIGS. 2-12 may be implemented as the computing system 1300. As depicted in FIG. 13, the computing system 1300 comprises a hardware processor element 1302 (e.g., comprising one or more hardware processors, which may include one or more microprocessor(s), one or more central processing units (CPUs), and/or the like, where hardware processor element may also represent one example of a “processing system” as referred to herein), a memory 1304, (e.g., random access memory (RAM), read only memory (ROM), a disk drive, an optical drive, a magnetic drive, and/or a Universal Serial Bus (USB) drive), a module 1305 for selecting a feature to train a classification model associated with a target variable based upon a significance metric that is based on a difference between a highest sub-volume and a lowest sub-volume for subsets of records of a data set including feature values of the feature, and various input/output devices 1306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 1302 is shown, it should be noted that the computing device may employ a plurality of hardware processor elements. Furthermore, although only one computing device is shown in FIG. 13, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 13 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor element 1302 can also be configured or programmed to cause other devices to perform one or more operations as discussed above. In other words, the hardware processor element 1302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 1305 for selecting a feature to train a classification model associated with a target variable based upon a significance metric that is based on a difference between a highest sub-volume and a lowest sub-volume for subsets of records of a data set including feature values of the feature (e.g., a software program comprising computer-executable instructions) can be loaded into memory 1304 and executed by hardware processor element 1302 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 1305 for selecting a feature to train a classification model associated with a target variable based upon a significance metric that is based on a difference between a highest sub-volume and a lowest sub-volume for subsets of records of a data set including feature values of the feature (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, a data set comprising a plurality of records, each record of the plurality of records associating at least one feature value of at least one feature with a value of a target variable;
segregating, by the processing system, the plurality of records into a plurality of subsets based upon a range of values of the at least one feature;
calculating, by the processing system, a plurality of sub-volumes for the plurality of subsets, each sub-volume of the plurality of sub-volumes comprising a sum of the values of the target variable from records of the plurality of records in a respective subset of the plurality of subsets;
generating, by the processing system, a significance metric that is based on a difference between a highest sub-volume and a lowest sub-volume of the plurality of sub-volumes; and
selecting, by the processing system, the at least one feature to train a classification model associated with the target variable, wherein the selecting is based upon the significance metric.

2. The method of claim 1, further comprising:
calculating a global volume comprising a total sum of the values of the target variable from the plurality of records.

3. The method of claim 2, further comprising:
dividing each of the plurality of sub-volumes by the global volume to generate a plurality of scaled sub-volumes.

4. The method of claim 3, wherein the generating of the significance metric comprises calculating a different between a highest scaled sub-volume and a lowest scaled sub-volume of the plurality of sub-volumes.

5. The method of claim 1, wherein the target variable comprises a binary variable.

6. The method of claim 1, wherein the at least one feature comprises a plurality of features, wherein the selecting comprises selecting a set of features from among the plurality of features, the set of features including the at least one feature.

7. The method of claim 6, wherein the set of features comprises:
a defined number of features having the highest significance metrics from among a plurality of significance metrics of the plurality of features;
a percentage of a total number of the plurality of features having the highest significance metrics from among a plurality of significance metrics of the plurality of features; or
features of the plurality of features having significance metrics above a threshold.

8. The method of claim 6, further comprising:
training the classification model to predict an output value of the target variable in accordance with input data comprising a set of input values of the set of features.

9. The method of claim 8, wherein the data set comprises telecommunication network operational data of a telecommunication network and wherein the target variable comprises a network condition.

10. The method of claim 9, further comprising:
applying the input data to the classification model to generate the output value of the target variable; and
reconfiguring at least one aspect of the telecommunication network based on the output value.

11. The method of claim 1, further comprising:
identifying a feature type of the at least one feature.

12. The method of claim 11, wherein when the feature type of the at least one feature is identified as a numerical feature type, wherein the segregating comprises:
determining a range of feature values of the at least one feature; and
dividing the range of feature values into a plurality of sub-intervals, wherein each of the subsets is defined by a respective sub-interval of the plurality of sub-intervals, and wherein each of the subsets comprises records of the plurality of records having a respective feature value of the at least one feature that is within the respective sub-interval.

13. The method of claim 12, wherein the plurality of sub-intervals comprises uniform sub-intervals.

14. The method of claim 11, wherein when the feature type of the at least one feature is identified as a categorical feature type, each of the plurality of subsets is associated with a different category of a plurality of categories of the at least one feature.

15. The method of claim 14, wherein the segregating comprises segregating the plurality of records according to the plurality of categories.

16. The method of claim 14, wherein the categorical feature type comprises a binary feature type or a logical feature type.

17. The method of claim 11, wherein when the feature type of the at least one feature is identified as an integer feature type, each of the plurality of subsets is associated with a different integer value of a plurality of integer values of the at least one feature.

18. The method of claim 17, wherein the segregating comprises segregating the plurality of records according to the plurality of integer values.

19. A device comprising:
a processing system including at least one processor; and
a computer-readable medium storing instructions which, when executed by the processing system, cause the processing system to perform operations, the operations comprising:
obtaining a data set comprising a plurality of records, each record of the plurality of records associating at least one feature value of at least one feature with a value of a target variable;
segregating the plurality of records into a plurality of subsets based upon a range of values of the at least one feature;
calculating a plurality of sub-volumes for the plurality of subsets, each sub-volume of the plurality of sub-volumes comprising a sum of the values of the target variable from records of the plurality of records in a respective subset of the plurality of subsets;
generating a significance metric that is based on a difference between a highest sub-volume and a lowest sub-volume of the plurality of sub-volumes; and
selecting the at least one feature to train a classification model associated with the target variable, wherein the selecting is based upon the significance metric.

20. A non-transitory computer-readable storage medium storing instructions which, when executed by a processing system including at least one processor, cause the processing system to perform operations, the operations comprising:
obtaining a data set comprising a plurality of records, each record of the plurality of records associating at least one feature value of at least one feature with a value of a target variable;
segregating the plurality of records into a plurality of subsets based upon a range of values of the at least one feature;
calculating a plurality of sub-volumes for the plurality of subsets, each sub-volume of the plurality of sub-volumes comprising a sum of the values of the target variable from records of the plurality of records in a respective subset of the plurality of subsets;
generating a significance metric that is based on a difference between a highest sub-volume and a lowest sub-volume of the plurality of sub-volumes; and
selecting the at least one feature to train a classification model associated with the target variable, wherein the selecting is based upon the significance metric.
